(19) United States
(12) Patent Application Publication
(10) Pub. No.: US 2009/0149616 A1
(43) Pub. Date: Jun. 11, 2009

(54) FLUORINATED SURFACTANTS

(76) Inventors: Frans A. Audenaert, Kaprijke (BE); Rudolf J. Dams, Zwijndrecht (BE)

Correspondence Address: 3M INNOVATIVE PROPERTIES COMPANY, PO BOX 33427, ST. PAUL, MN, 55133-3427, US

(21) Appl. No.: 12/095,205

(22) PCT Filed: Nov. 22, 2006
(86) PCT No.: PCT/US06/45223

§ 371 Date: Sep. 30, 2008

(30) Foreign Application Priority Data
Dec. 1, 2005 (GB) 0524483.5

(51) Int. Cl. C08F 14/18

(52) U.S. Cl. 526/247

(57) ABSTRACT

The present invention provides a fluorinated surfactant comprising fluorinated units and hydrophilic non-fluorinated units wherein said fluorinated surfactant can be obtained by

(i) a free radical polymerization of:
(a) one or more fluorinated monomers having the general formula (I):

(R_{f})ₙ—X—C(R¹)═CH₂ (I)
wherein R_{f} represents a perfluorinated polyether group, X represents a bond or a linking group, R¹ represents a hydrogen atom or an alkyl group of 1 to 4 carbon atoms, and n is 1 or 2; and
(b) at least one non-fluorinated monomer having at least one hydrophilic group or a precursor thereof; and
   (ii) conversion of said precursor when present, into a corresponding hydrophilic group.

### PRIORITY CLAIM

This application is a national stage filing under 35 U.S.C. 371 of PCT/US2006/045223, filed Nov. 22, 2006, which claims priority to Great Britain Application No. 0524483.5, filed Dec. 1, 2005, the disclosure of which is incorporated by reference in its/their entirety herein.

### FIELD OF INVENTION

The invention relates to novel fluorinated surfactants derived from fluorinated monomers having a perfluorinated polyether group and at least one non-fluorinated monomer having at least one hydrophilic group or a precursor thereof. The surfactants have been found to be efficient and effective in lowering the surface energy of a liquid medium comprising organic solvents and/or water.

### BACKGROUND

Fluorinated surfactants are known and described generally in “Fluorinated Surfactants” by E. Kissa, Surfactants Science Series, Vol. 50 (Marcel Dekker, New York 1994). Fluorinated surfactants, including those derived from fluorinated polyethers are also described in U.S. Pat. Nos. 3,644,492; 3,798,265; 3,555,089; 3,621,059; 3,944,610; and 3,536,710. There is an ever growing environmental awareness and the fluorinated polyethers disclosed in the art, in particular those that have been disclosed for use as surfactants, may no longer meet today's expectations with respect to the environmental properties and impact of compositions based on such polyethers. It is a particularly desired environmental property that the fluorinated surfactants are substantially free of fluorinated components that eliminate slowly from the body of living organisms. Additionally, it is desired that the fluorinated surfactants have a sufficient stability under normal conditions of use and storage such that they do not decompose into fluorinated components that eliminate slowly from the body of living organisms.

Surfactants derived from mixtures of fluorinated polyethers, more in particular, fluorinated polyethers derived from hexafluoropropyleneoxide, have been described more recently in US Patent Publication No. 2005/096244. Such surfactants, having a molecular weight between 750 g/mol and 5000 g/mol, have been described as having good or excellent environmental properties combined with good or excellent surfactant properties.

There remains a need to find further beneficial fluorinated surfactants and, in particular, fluorinated surfactants that are environmentally friendly and are effective and efficient in a broad variety of applications. Preferably such fluorinated surfactants will have a high molecular weight combined with high solubility in organic solvents and water.

Desirably, the fluorinated surfactants are easy to manufacture in a cost effective and convenient way.

### SUMMARY OF INVENTION

The invention provides in one aspect a fluorinated surfactant comprising fluorinated units and hydrophilic non-fluorinated units wherein said fluorinated surfactant can be obtained by

(i) a free radical polymerization of:
(a) one or more fluorinated monomers having the general formula (I):

(R_{f})ₙ—X—C(R¹)═CH₂ (I)
wherein R_{f} represents a perfluorinated polyether group, X represents a bond (when n is 1) or a linking group, R¹ represents a hydrogen atom or an alkyl group of 1 to 4 carbon atoms, and n is 1 or 2; and
(b) at least one non-fluorinated monomer having at least one hydrophilic group or a precursor thereof; and
   (ii) conversion of said precursor when present, into a corresponding hydrophilic group.

By the term “surfactant” is meant a substance that, when present at low concentration in a system, has the property of absorbing onto the surfaces or interfaces of the system and of altering to a marked degree the surface or interfacial free energies of these surfaces.” (Milton J. Rosen, “Surfactants and Interfacial Phenomena,” Second Ed., John Wiley & Sons, New York, N.Y., 1989, page 1). The fluorinated surfactants according to the invention have been found to have these properties. In one aspect, the invention provides a method of altering the surface energy and/or interfacial free energy of a liquid medium, the method comprising providing a liquid medium and incorporating a fluorinated surfactant as described herein in the medium.

In another aspect, the invention provides a composition comprising an organic or aqueous liquid having dispersed or dissolved therein a fluorinated surfactant as defined above.

In a particular aspect, the invention provides a fluorinated surfactant wherein said perfluoropolyether group corresponds to the general formula:

CF₃CF₂CF₂O[CF(CF₃)CF₂O]ₖCF(CF₃)—

wherein k has a value of at least 1.

It has been found that fluorinated surfactants as described above have good or excellent environmental properties combined with good or excellent surfactant properties. In particular, the surfactant properties are typically such that the surfactants can be used in a wide variety of applications. Furthermore, the surfactants may generally be prepared without processing difficulties.

### DETAILED DESCRIPTION OF ILLUSTRATIVE EMBODIMENTS

The fluorinated surfactant according to the invention can be obtained by free radical polymerization of one or more fluorinated monomers, comprising a perfluorinated polyether group, and at least one non-fluorinated monomer having at least one hydrophilic group or a precursor thereof. By “perfluorinated polyether group” is meant a fluorinated polyether group that consists of carbon and fluorine and that contains at least two ether linkages.

The fluorinated monomers useful in the synthesis of the fluorinated surfactant according to the invention can be represented by the formula:

(R_{f})ₙ—X—C(R¹)═CH₂ (I)

wherein R_{f} represents a perfluorinated polyether group, R¹ represents a hydrogen atom or an alkyl group of 1 to 4 carbon atoms, and n is 1 or 2. X is a bond or a divalent linking group, generally non-fluorinated. Examples of linking groups include *-CH₂-L¹-, *-COO-L²-, *-CONR^{a}-L²-, wherein L¹ represents a chemical bond or a divalent linking group, L² represents a divalent linking group and R^{a} is hydrogen or an alkyl group having 1 to 4 carbon atoms and * indicates the position where the linking group is attached to the group R_{f} in formula (I). Examples of divalent linking groups L¹ include an oxy group, an amido group, a carboxy group, a carbonyl group, an aryl group that may be substituted and an alkylene group that may be substituted and/or that may be interrupted with one or more heteroatoms or with an amido group, a carboxy group, a urethane group or a carbonyl group. Examples of divalent linking groups L² include an aryl group that may be substituted and an alkylene group that may be substituted and/or that may be interrupted with one or more heteroatoms or with an amido group, a carboxy group, a urethane group, or a carbonyl group. Particular suitable linking groups X include *-CONR^{a}-L²-, wherein R^{a} is hydrogen and L² includes an alkylene group substituted with a carboxy group.

In one embodiment, the perfluorinated polyether group R_{f} of the fluorinated monomer of formula (I) corresponds to the formula:

R¹_{f}—O-(R_{f}²-)_{z}(R_{f}³)_{q}

wherein R¹_{f} represents a perfluorinated alkyl group, R_{f}² represents a perfluorinated alkyleneoxy group consisting of perfluorinated alkyleneoxy groups having 1, 2, 3 or 4 carbon atoms or a mixture of such perfluorinated alkylene oxy groups and z is at least 1, R³_{f} represents a perfluorinated alkylene group and q is 0 or 1. The perfluorinated alkyl group R¹_{f} in the above formula may be linear or branched and may comprise 1 to 10 carbon atoms, for example, 1 to 6 carbon atoms. A typical perfluorinated alkyl group is CF₃CF₂CF₂—. R³_{f} is a linear or branched perfluorinated alkylene group that will typically have 1 to 6 carbon atoms. For example, R³_{f} is —CF₂— or —CF(CF₃)—. Examples of perfluorinated polyalkyleneoxy group R²_{f} include: —CF₂CF₂O—, —CF(CF₃)CF₂O—, —CF₂CF(CF₃)O—, —CF₂CF₂CF₂O—, —CF₂O—, —CF(CF₃)O—, and —CF₂CF₂CF₂CF₂—O.

The perfluorinated polyalkyleneoxy group may be comprised of the same perfluorinated alkylene oxy units or of a mixture of different perfluorinated alkylene oxy units. When the perfluorinated polyalkyleneoxy group is composed of different perfluorinated alkylene oxy units, they can be present in a random configuration, alternating configuration or they can be present as blocks. Typical examples of perfluorinated polyalkylene oxy moieties (R_{f}²)_{z} in the above formula include: —[CF₂CF₂O]ᵣ—; —[CF(CF₃)CF₂O]ₛ—; —[CF₂CF₂O]ᵢ[CF₂O]ⱼ—; and —[CF₂CF₂O]ₗ—[CF(CF₃)CF₂O]ₐ—; wherein r is an integer of 4 to 25, s is an integer of 1 to 25 and i, l, a, and j each are integers of 2 to 25.

In a particular embodiment of the invention, the perfluorinated polyether group corresponds to the general formula:

CF₃CF₂CF₂O[CF(CF₃)CF₂O]ₖCF(CF₃)—

wherein k has a value of at least 1. Perfluorinated polyether groups of the above formula can conveniently be derived from the oligomerization of hexafluoropropyleneoxide and are of particularly suitable from an environmental point of view.

In a particular suitable embodiment, k is an integer of 3 to 25 and the corresponding perfluorinated polyether group has a weight average molecular weight of at least 750 g/mol.

Thus, in a particular embodiment of the invention, the fluorinated monomer corresponds to the formula:

CF₃CF₂CF₂O[CF(CF₃)CF₂O]ₖCF(CF₃)—X—C(R¹)═CH₂ (Ia)

wherein k has a value of at least 1, R¹ represents hydrogen or an alkyl group of 1 to 4 carbon atoms, and X is a divalent linking group as defined above.

Mixtures of fluorinated monomers according to formula (Ia) can be used in the polymerization reaction to form the fluorinated surfactant. Preferably a major part or all of the perfluorinated polyether groups of the fluorinated monomers or mixture of fluorinated monomers have a weight average molecular weight of at least 750 g/mol. Preferably not more than 10%, more preferably not more than 5% by weight and most preferably not more than 1% by weight of the perfluorinated polyether groups in the fluorinated monomers or mixture of fluorinated monomers and the corresponding fluorinated surfactants have a weight average molecular weight of less than 750 g/mol.

Examples of fluorinated monomers according to formula (I) and/or (Ia) include:

R_{f}—CONR″—(CH₂)ₘO—COC(R′)═CH₂

R_{f}—COOCH₂CH(OH)CH₂O—COC(R′)═CH₂

R_{f}—CONR″—(CH₂)ₘO—CONHCH₂CH₂—OCO—C(R′)═CH₂

R_{f}—CONR″—(CH₂)ₘO—CONHCO—C(R′)═CH₂

R_{f}—CONR″—(CH₂)ₘO—CONHC(Me)₂—C₆H₄—C(Me)═CH₂

R_{f}—CH₂O—COC(R′)═CH₂

with m being 2, 3, 4, 6, 8, 10, or 11; R″ being hydrogen, methyl, ethyl, propyl, butyl, or hexyl, and R′ is H or methyl; Me is methyl; and R_{f} has the meaning as defined above and is preferably CF₃CF₂CF₂O[CF(CF₃)CF₂O]ₖCF(CF₃)—.

The fluorinated monomers of the above formula (I) and (Ia) can be readily obtained starting from, e.g., acid, ester, alcohol or acid halide terminated perfluorinated polyether and reacting with appropriate reactants to introduce the ethylenically unsaturated group and linking group X. These reactions are well-known to those skilled in the art and examples of suitable reactions and reactants to introduce the ethylenically unsaturated group and linking group X can be found for example in EP 870 778. For example, the following table lists some —X—C(R)═CH₂ end groups that can be obtained from a reaction of an acid, acid fluoride, or ester terminated perfluorinated polyether with the indicated reactant:

| | Reactant |
|---|---|
| —CONHCH₂CH₂—OOC—CH═CH₂ | 1) H₂NCH₂CHOH |
| | 2) acryloylchloride |
| —CONHCH₂—CH═CH₂ | H₂NCH₂—CH═CH₂ |
| —CONH—C₆H₄—CH₂CH═CH₂ | H₂N—C₆H₄—CH₂CH═CH₂ |
| —COOCH₂CH═CH₂ | CH₂═CH—CH₂—OH |
| —CH₂OCH₂CH═CH₂ | 1) reduction with LiAlH₄ to CH₂OH |
| | 2) CH₂═CHCH₂Br |
| —CH₂OOC—C(CH₃)═CH₂ | 1) reduction with LiAlH₄ to CH₂OH |
| | 2) methacryloyl chloride |
| —CH₂OCONH—CH₂CH₂—OOC—CH═CH₂ | 1) reduction with LiAlH₄ to CH₂OH |
| | 2) OCN—CH₂CH₂—OOC—CH═CH₂ |

Non-fluorinated monomers having at least one hydrophilic group or a precursor thereof include for example hydrocarbon group containing monomers such as monomers that can be represented by formula:

Rₕ-L-Z (II)

wherein Rₕ represents a hydrocarbon group, e.g., an aliphatic group, having at least one hydrophilic group or a precursor thereof, L represents a bond or a divalent linking group, and Z represents an ethylenically unsaturated group. Examples of linking group L include oxy, carbonyl, amid and carbonyloxy.

In a particular embodiment of the invention, the non-fluorinated monomer can be represented by the formula:

CH₂═C(R²)C(O)X¹—(C_{n′}H_{2n′})Y (III)

wherein X¹ is O, N(R³), or S; R³ is hydrogen or an alkyl group of 1 to 4 carbon atoms, R² is hydrogen or methyl, n′ is an integer from 0 to 20; and Y is a hydrophilic group or a precursor thereof.

The hydrophilic group Y can be selected from the group consisting of non-ionic, anionic, cationic and amphoteric groups or precursors thereof.

Examples of non-ionic groups include straight or branched alkyleneoxy groups having 2 to 6 carbon atoms, for example 2, 3, or 4 carbon atoms, such as in ethyleneoxy (EO) or propyleneoxy (PO). When ethyleneoxy and propyleneoxy units are linked together, they generally form polyethyleneoxy or polypropyleneoxy blocks or a mixture of blocks. Particularly useful polyalkyleneoxy groups are those comprising a center block of polyoxypropylene units and blocks of polyoxyethylene units to each side of the center block. These groups have the formula shown below:

-(EO)ᵥ—(PO)_{w}(EO)_{μ}

wherein w is an integer of about 1 to about 54 and v and μ independently are integers of about 2 to about 128. Additional useful polyakyleneoxy groups are those having a center block of polyoxyethylene units and blocks of polyoxypropylene units to each side of the center block. These polyoxyalkylene groups have the formula as shown below:

—(PO)_{v′}-(EO)_{w′}—(PO)_{μ′}—

wherein w′ is an integer of about 1 to about 164, and v′ and μ′ independently are integers of about 2 to about 22.

Examples of cationic groups include quaternary amines.

In a particular embodiment, the group Y can be represented by the formula:

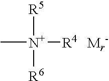

wherein each of R⁴, R⁵ and R⁶ independently represents a hydrogen atom or a hydrocarbon group that may optionally be substituted, M⁻ represents a counter ion, r is 0 or 1, and when r is 0, one of R⁴, R⁵, and R⁶ represents a hydrocarbon group that is substituted with an acid group, such as, for example, —CH₂CH₂CH₂SO₃⁻. Representative examples of M⁻ include Cl⁻, CH₃COO⁻, C₂H₅SO₄⁻, I⁻, Br⁻, CF₃SO₃⁻, ½SO₄²⁻.

In a further embodiment, the hydrophilic group Y corresponds to the formula:

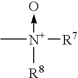

wherein R⁷ and R⁸ are independently C₁₋₆-alkyl, C₁₋₆-alkyl substituted by halogen, C₁₋₆-alkoxy, NO₂, or CN, or R⁷ and R⁸ may join to form a 5 to 7 membered ring that may contain one or more additional hetero atoms and that may be substituted by one or more C₁₋₆-alkyl groups.

Examples of anionic groups include sulfonates (e.g., —SO₃M′), sulphates (e.g., —OSO₃M′), carboxylates (e.g., —COOM′), phosphates (e.g., OPO₃M′), and phosphonates (e.g., —PO₃M′) wherein M′ is hydrogen, a metal cation such as an alkali or alkaline earth metal cation (e.g., sodium, potassium, calcium or magnesium) or a nitrogen-based cation, such as, for example, ammonium or a protonated tertiary amine (e.g., (HOCH₂CH₂)₂N⁺HCH₃).

Examples of amphoteric groups include zwitterionic species, e.g., —N(R⁹)₂—(CH₂)_{z}COOH and —N(R⁹)₂—(CH₂)_{z}SO₃H wherein R⁹ is hydrogen or a C₁₋₄ alkyl group.

Examples of precursors of hydrophilic groups include amino groups, esters including carboxylic and sulphonic acid esters, carboxylamides, sulfonamides and hydroxyl groups.

Non-fluorinated monomers having at least one hydrophilic group or a precursor thereof are commercially available. Particularly useful monomers having a hydrophilic group include monomers comprising polyoxyalkylene groups. Examples include (meth)acylates of polyethylene glycol, such as CARBOWAX™ A, commercially available from Union Carbide and (meth)acrylates of block copolymers of ethylene oxide and propylene oxide, such as PLURONIC™ A, commercially available from BASF. Further examples include (meth)acrylates of amino or diamino terminated polyethers and (meth)acrylates of methoxypolyethylene glycols.

Further useful monomers having a hydrophilic group include alkyl(meth)acrylates having an ammonium group such as (meth)acrylates of the formula X″⁻R^{a}₃N⁺—R^{b}—OC(O)—CR^{c}═CH₂ wherein X″⁻ represents an anion such as e.g. a chloride anion, R^{a} represents hydrogen or an alkyl group and each R^{a} may the same of different, R^{b} represents an alkylene and R^{c} represents hydrogen or methyl.

Particularly useful monomers having a hydrophilic group or a precursor of a hydrophilic group include hydrocarbon monomers having an acid group, such as (meth)acrylic acid or 2-acrylamido-2-methyl-1-propane sulfonic acid (AMPS); monomers containing a hydroxyl group, including hydroxyl group containing (meth)acrylates, such as hydroxyethyl(meth)acrylate and hydroxypropyl(meth)acrylate. Further useful monomers include aminoalkyl(meth)acrylates such as N,N-diethylaminoethylmethacrylate, N,N′-dimethylaminoethylmethacrylate, and N-t-butylaminoethylmethacrylate.

Non-fluorinated monomers having polyalkyleneoxy groups are particularly useful because they typically increase the solubility of the fluorinated surfactant over a wide range of polarity and pH and, by alteration of the carbon-oxygen ratio, can be tailored for any particular matrix.

In the synthesis of the fluorinated surfactants, mixtures of monomers having a hydrophilic group or precursor thereof can be used, in order to prepare fluorinated surfactants that have mixtures of hydrophilic groups. For examples, monomers comprising non-ionic groups can be used in combination with monomers having cationic or anionic groups or precursors thereof, in order to prepare a fluorinated surfactant having a combination of non-ionic and cationic or anionic groups.

The fluorinated surfactant is typically prepared by free radical polymerisation of one or more fluorinated monomers with at least one non-fluorinated monomer having at least one hydrophilic group or a precursor thereof. As a result, the weight ratio of corresponding fluorinated units to hydrophilic non-fluorinated units may be from 80:20 to 1:99.

A free radical initiator is generally used to initiate the polymerization reaction. Useful free radical initiators are known in the art and include azo compounds, such as azobisisobutyronitrile (AIBN), azobisvaleronitrile, and azobis(2-cyanovaleric acid), 2,2′-azobis(2-amidinopropane)dihydrochloride and the like, hydroperoxides such as cumene, t-butyl, and t-amyl hydroperoxide, dialkyl peroxides such as di-t-butyl and dicumylperoxide, peroxyesters such as t-butylperbenzoate and di-t-butylperoxy phtalate, and diacylperoxides such as benzoyl peroxide and lauroyl peroxide.

The polymerization reaction can be carried out in any solvent suitable for organic free-radical reactions. The reactants can be present in the solvent at any suitable concentration, e.g., from 5% to 90% by weight based on the total weight of the reaction mixture. Examples of suitable solvents include aliphatic and alicyclic hydrocarbons (e.g., hexane, heptane, cyclohexane), aromatic solvents (e.g., benzene, toluene, xylene), ethers (e.g., diethylether, glyme, diglyme, diisopropyl ether), esters (e.g., ethyl acetate, butyl acetate), alcohols (e.g., ethanol, isopropyl alcohol), ketones (e.g., acetone, methylethyl ketone, methyl isobutyl ketone), sulfoxides (e.g., dimethyl sulfoxide), amides (e.g., N,N-dimethylformamide, N,N-dimethylacetamide), halogenated solvents such as methylchloroform, FREON™113, trichloroethylene, α,α,α-trifluorotoluene, hydrofluoroethers, (e.g., NOVEC™ HFE-7100, 7200 and 7500, commercially available from 3M), and mixtures thereof.

The polymerization reaction can be carried out at any temperature suitable for conducting an organic free-radical reaction. Particular temperature and solvents for use can be easily selected by those skilled in the art based on considerations such as the solubility of reagents, the temperature required for the use of a particular initiator, molecular weight desired and the like. While it is not practical to enumerate a particular temperature suitable for all initiators and all solvents, generally suitable temperatures are between 30° C. and 200° C.

The fluorinated surfactant is typically prepared in the presence of a chain transfer agent. Suitable chain transfer agents typically include a hydroxy-, amino-, or mercapto group. The chain transfer agent may include two or more of such hydroxy, amino-, or mercapto groups. Suitable chain transfer agents useful in the preparation of the fluorinated surfactant include those selected from 2-mercaptoethanol, 3-mercapto-2-butanol, 3-mercapto-2-propanol, 3-mercapto-1-propanol, 3-mercapto-1,2-propanediol, 2-mercapto-ethylamine, di(2-mercaptoethyl)sulfide, octylmercaptane, and dodecylmercaptane.

The polymerisation conditions and chain transfer agent may be chosen to tailor the molecular weight and/or properties of the fluorinated surfactant. The method of making the fluorinated surfactant will result in a mixture of surfactants that have a different molecular weight. For environmental reasons, the weight average molecular weight of the fluorinated surfactant is typically tailored to be at least 1000 g/mol, suitably at least 2000 g/mol and particularly suitable at least 3000 g/mol. Typically the fluorinated surfactant will have a weight average molecular weight such that it is readily dissolved or dispersed in a liquid medium comprising water or an organic solvent or mixtures thereof. Typically, the fluorinated surfactants have a solubility of at least 0.001% by weight, suitable at least 0.005% by weight and particularly suitable at least 0.01% by weight at 20° C. in at least one solvent selected from the group consisting of water and a non-fluorinated solvent. Generally the weight average molecular weight of the fluorinated surfactant is tailored to be not more than 100,000 g/mol, suitable not more than 80,000 g/mol and particularly suitable not more than 50,000 g/mol.

In case the above described free radical polymerization involves one or more monomers having a precursor of a hydrophilic group, it will be required to convert such groups into desired hydrophilic groups. Generally such conversion will be carried out subsequent to the polymerization although it is also conceivable to carry out the conversion concurrent with the polymerization. The conversion may proceed according to any of the methods known to those skilled in the art including for example hydrolysis of for example an ester or sulfonamide group, protonation, oxidation or quaternation of an amine.

For example, in one embodiment, a tertiary amine group can be reacted with a peroxy acid or hydrogen peroxide to form an amine-oxide group. In a further embodiment, such tertiary amine group can be quaternized by an alkyl halogenide, such as methyl iodide for example, to form a cationic group. In an alternative embodiment, the tertiary amine group can also be reacted with a cyclic sultone or lactone to form an amphoteric group. In another embodiment, an alcohol functional group can be reacted with POCl₃ to form a phosphate group or with chloroacetic acid to form a carboxylate group. In a further embodiment, the alcohol functional group can be reacted with, e.g., a cyclic sultone to form a sulfonate group.

The fluorinated surfactants can readily be dispersed or dissolved in water or an organic liquid or mixtures thereof. Examples of useful organic liquids include aliphatic and alicyclic hydrocarbons (e.g., hexane, heptane, cyclohexane), aromatic solvents (e.g., benzene, toluene, xylene), ethers (e.g., diethylether, glyme, diglyme, diisopropylether), alkoxy alkylene ethers (e.g., dipropylene glycol monomethylether, triethyleneglycol monomethylether, methoxy propanol), esters, (e.g., ethyl acetate, butyl acetate, butoxyethyl acetate), alcohols (e.g., ethanol, isopropyl alcohol), ketones (e.g., acetone, methyl ethyl ketone, methyl isobutyl ketone), sulfoxides (e.g., dimethyl sulfoxide), amides (e.g., N,N-dimethylformamide, N,N-dimethylacetamide, N-methylpyrrolidinone), halogenated solvents selected from the group consisting of hydrofluoroethers, hydrofluorocarbons and chlorinated solvents, such as methylchloroform, FREON™113, trichloroethylene, α,α,α-trifluorotoluene, and mixtures thereof.

The fluorinated surfactants have been found to have good or excellent surfactant properties such that they can be used in a wide variety of applications where surfactant properties are desired and/or needed. In particular, the fluorinated surfactants are very effective in reducing the surface energy of liquids, including organic liquids and water. Similarly the surfactants may improve the wetting, levelling and spreading of a surface of a substrate by a liquid or coating mixture.

The fluorinated surfactants may be useful as levelling agents and surface tension controllers in paints and coatings. The surfactants may further find utility in emulsion polymerization of monomers.

The fluorinated surfactants can be used individually or in combination to produce the desired surface tension reduction or wetting improvement. In one embodiment of the invention, the fluorinated surfactants are formulated into an organic or aqueous liquid at a final concentration of about 0.001 to 1% by weight based on the weight of the liquid.

The above embodiments are some of the applications in which the surfactant properties of the fluorinated surfactants can be used without however excluding that the fluorinated surfactants may be used in other applications as well where surfactant properties are desired. The invention will now be further illustrated by means of specific examples without however the intention to limit the invention thereto.

### EXAMPLES

The surface tension of aqueous and organic solutions was determined by Wilhelmy plate method using a KRUSS™ K12 Tensiometer. The tensiometer was integrated with an automatic dosimat and a computer, using a software package for dynamic contact angle (K121). The program was run using a Wilhelmy platinum plate (PL12) and glass sample vessel (GL7).

### ABBREVIATIONS

PLURONIC™ 44A: mono-acrylate of Pluranic 44 diol, available from BASF;
CW750A: acrylate of CARBOWAX™ 750, a monofunctional polyethyleneglycol with average MW 750, available from Union Carbide;
DMAEMA: dimethylaminoethylmethacrylate;
DPM: dipropyleneglycol monomethylether, available from DOW;
TEGME: triethyleneglycolmonomethylether, available from Sigma-Aldrich;
BEAc: butoxyethylacetate, available from Sigma-Aldrich;
EtOAc: ethyl acetate;
MEK: methyl ethyl ketone;
AIBN: azo bis isobutyronitrile;
HFE-7200: NOVEC™ HFE-7200 Hydrofluoroether, available from 3M; and
(HFPO)_{7.35}-ester: CF₃CF₂CF₂O(CF(CF₃)CF₂O)_{5.35}CF(CF₃)COCH₃, consisting of a mixture of oligomers with different chain lengths. The index 5.35 is indicative of the mathematical average of the number of repeating HFPO-units. The weight average molecular weight of the ester was 1232 g/mol.

### Synthesis of fluorinated polyether acrylate derivatives (═(HFPO)ₙ-acrylate)

(HFPO)_{7.35}-acrylate: C₃F₇O(C₃F₆O)_{5.35}CF(CF₃)CONHCH₂CH₂OCOCH═CH₃, was prepared via a two step reaction, starting from the corresponding (HFPO)_{7.35}-ester: C₃F₇O(C₃F₆O)_{5.35}CF(CF₃)COOCH₃.

In a first step, the (HFPO)_{7.35}-ester was converted to the corresponding alcohol C₃F₇O(C₃F₆O)_{5.35}CF(CF₃)CONHCH₂CH₂OH. (═(HFPO)_{7.35}-alc).

A 1 liter 3-necked reaction flask was equipped with a stirrer, a condenser, a dropping funnel, a heating mantle and a thermometer. The flask was charged with 1000 g CF₃CF₂CF₂—O—(CF(CF₃)CF₂O)_{5.35}CF(CF₃)COOCH₃. The mixture was heated to 40° C. and 43.4 g ethanolamine was added via the dropping funnel, over a period of 30 minutes. The reaction mixture was kept at 65° C. during 3 hours. FTIR analysis indicated complete conversion. The end product was purified as follows: 500 ml ethyl acetate were added and the organic solution was washed with 200 ml HCL (1N), followed by 2 washings with 200 ml brine. The organic phase was dried over MgSO₄. Ethyl acetate was evaporated with water jet vacuum, using a BÜCHI™ rotary evaporator. The product was dried at 50° C. during 5 hours, using oil pump vacuum (<1 mbar). An alternative purification step included evaporation of methanol, formed during reaction, via water jet vacuum, using a BÜCHI™ rotary evaporator (up to 75° C.=<100 mm Hg). Residual methanol was further removed with oil pump vacuum (up to 80° C., =<10 mbar).

The (HFPO)_{7.35}-alc obtained, was a yellow coloured oil. The structure was confirmed by means of NMR.

In a second step, (HFPO)_{7.35}-acrylate was prepared.

In a 500 ml three necked flask fitted with a stirrer, thermometer and condenser were placed, 126.1 g (0.1 mol) of (HFPO)_{7.35}-alc, 60 g MEK, 60 g HFE-7200, 0.1 mol (10.1 g) of triethylamine, 0.01 g MEHQ and 0.01 g phenothiazine. The mixture was cooled to 5° C. in an ice bath. Then 0.11 mol acryloylchloride (10.1 g) were added drop wise over 1 hour under N₂. An exothermic reaction was noticed and precipitate formed. The temperature was allowed to rise to 25° C. under stirring over 1 hr. The reaction was continued for 1 hr under nitrogen at 50° C. The resulting reaction mixture was washed 3 times with 200 ml of water and the organic layer was separated off.

All solvents were distilled off at 50° C. under vacuum. A clear, yellow brown liquid resulted, which was identified to be (HFPO)_{7.35}-acrylate.

### Synthesis of Fluorinated Surfactants

Several fluorinated surfactants were prepared as given below. The composition of the surfactants is given in table 1.

### Fluorinated Surfactants 1 and 2, Having Non-Ionic Hydrophilic Group

Synthesis of fluorinated surfactant 1: In a three necked flask of 250 ml, were placed 30 g of above prepared (HFPO)_{7.35}-acrylate, 140 g of a 50% solution of PLURONIC™ 44A in toluene, 30 g toluene, 5 g of 3-mercapto-1.2 propanediol, and 0.5 g AIBN. The reaction was degassed 3 times using nitrogen and aspirator vacuum. The reaction mixture was heated up to 70° C. under nitrogen and reacted for 6 hrs. Another charge of 0.1 g AIBN was added and the reaction was continued for 16 hrs under nitrogen at 70° C. A third charge of AIBN (0.05 g) was added and the reaction was continued for 3 hours at 70° C. Solvent was stripped off at about 80° C. and aspirator vacuum. A clear, viscous, amber colored liquid resulted. A solution of 50% solids in dipropylenglycol monomethyl ether (DPM) was prepared.

Fluorinated surfactant 2 was made according to the same procedure, using CW 750 A instead of PLURONIC™ 44A.

### Fluorinated Surfactant 3, Having Amine-Oxide Hydrophilic Group

Fluorinated surfactant 3 was a fluorinated surfactant having an amine-oxide hydrophilic group and was prepared according to the general procedure as given for fluorinated surfactant 1, but using DMAEMA instead of PLURONIC™ 44A. After the reaction was completed, MEK was stripped and replaced with 100 g ethanol. Then 77 g (0.68 mol) H₂O₂ (30% solution in water) was added and the mixture was slowly heated up to 70° C. in air; the reaction was continued for 6 hours at 70° C. A clear solution of a fluorinated surfactant having amine-oxide group was obtained.

### Fluorinated Surfactant 4, Having a Quaternary Ammonium Hydrophilic Group

Fluorinated surfactant 4 was made generally according to the procedure as given for fluorinated surfactant 3. After the reaction was completed and before the solvent strip, 0.45 mole (68.7 g) diethylsulphate were added under nitrogen atmosphere at 30° C., over a period of 1 hour. An exothermic reaction resulted. The reaction was continued for 2 hrs at 70° C. under N₂ after which the solvent was evaporated at room temperature. A fluorinated surfactant having a quaternary ammonium group was obtained. A 50% solids solution was prepared in DPM.

### Fluorinated Surfactant 5, Having an Amphoteric Hydrophilic Group

Fluorinated surfactant 5 was prepared generally according to the procedure as given for fluorinated surfactant 3. After the reaction was completed and before the solvent strip, 0.45 mole (54.9 g) propanesultone were added under nitrogen at 30° C. over a period of 1 hour. An exothermic reaction occurred. The reaction was continued for 2 hours at 70° C. under nitrogen. The solvent was evaporated at room temperature. The fluorinated surfactant having an amphoteric hydrophilic group was dissolved (at 50% solids) in DPM.

### Fluorinated Surfactant 6, Having Non-Ionic and Anionic Hydrophilic Groups

Fluorinated surfactant 6 was prepared in two steps. In a first step the procedure, as given for fluorinated surfactant 1, was followed, but additionally acrylic acid was used as co-monomer. After the reaction was completed and before the solvent strip 0.14 mole (14.6 g) diethanolamine were added at 30° C. to neutralize the acid. The reaction was continued for 1 hour. The solvent was then stripped off as described in the synthesis of fluorinated surfactant 1. The fluorinated surfactant having non-ionic and anionic hydrophilic groups was dissolved in DPM at 50% solids.

TABLE 1
The composition of the fluorinated surfactants 1-6

| | | Non-fluorinated | | | |
|---|---|---|---|---|---|
| Fluorinated | (HFPO)_{7.35}- | monomer | | | |
| Surfactant | acrylate | (amount) | Solvent | Additive | Type |
| 1 | 30 g | PLURONIC ™ | toluene | / | non-ionic |
| | | 44A (70 g) | | | |
| 2 | 30 g | CW 750 A (70 g) | EtOAc | / | non-ionic |
| 3 | 30 g | DMAEMA (70 g) | MEK | H₂O₂ | amine-oxide |
| 4 | 30 g | DMAEMA (70 g) | MEK | diethylsulphate | quaternary |
| | | | | | ammonium |
| 5 | 30 g | DMAEMA (70 g) | MEK | propanesultone | amphoteric |
| 6 | 35 g | PLURONIC 44A | EtOAc | diethanolamine | anionic |
| | | (55 g); AA (10 g) | | | |

### Examples 1 to 23 and references Ref 1 to Ref 4

For examples 1 to 23, the fluorinated surfactants 1 to 6 were further diluted in different solvents or water (DIW) and at concentrations as given in table 2. The mixtures were stirred at room temperature for about 30 minutes. The references (Ref 1 to 4) were made of the different solvents or water without addition of fluorinated surfactant. All surface tensions were measured using the Wilhelmy Plate Method, at a temperature of 25° C. The results are given in table 2.

TABLE 2
Surface Tension measurement

| | | | Concentration | |
|---|---|---|---|---|
| | | | fluorinated | |
| | | Fluorinated | surfactant | Surface Tension |
| Ex. No | Solvent | Surfactant | (% by weight) | (mN/m) |
| 1 | DPM | 1 | 0.5 | 16.7 |
| 2 | DPM | 1 | 0.1 | 18.0 |
| 3 | DPM | 1 | 0.01 | 21.4 |
| Ref 1 | DPM | / | / | 28.2 |
| 4 | DIW | 1 | 0.1 | 20.6 |
| 5 | DIW | 2 | 0.01 | 23.2 |
| 6 | DIW | 3 | 0.1 | 20.7 |
| 7 | DIW | 3 | 0.01 | 24.2 |
| 8 | DIW | 3 | 0.001 | 35.9 |
| 9 | DIW | 4 | 0.1 | 21.5 |
| 10 | DIW | 4 | 0.01 | 24.6 |
| 11 | DIW | 4 | 0.001 | 39.4 |
| 12 | DIW | 5 | 0.1 | 20.2 |
| 13 | DIW | 5 | 0.01 | 24.9 |
| 14 | DIW | 5 | 0.001 | 37.0 |
| 15 | DIW | 6 | 0.1 | 22.4 |
| 16 | DIW | 6 | 0.01 | 24.8 |
| 17 | DIW | 6 | 0.001 | 28.1 |
| Ref 2 | DIW | / | / | 72.3 |
| 18 | TEGME | 2 | 0.5 | 18.7 |
| 19 | TEGME | 2 | 0.1 | 19.3 |
| 20 | TEGME | 2 | 0.01 | 22.7 |
| Ref 3 | TEGME | / | / | 36.0 |
| 21 | BEAc | 2 | 0.5 | 17.7 |
| 22 | BEAc | 2 | 0.1 | 18.3 |
| 23 | BEAc | 2 | 0.01 | 20.7 |
| Ref 4 | BEAc | / | / | 26.1 |

1. Fluorinated surfactant comprising fluorinated units and hydrophilic non-fluorinated units wherein said fluorinated surfactant can be obtained by
(i) a free radical polymerization of:
(a) one or more fluorinated monomers having the general formula (I):
(R_{f})ₙ—X—C(R¹)═CH₂ (I)
wherein R_{f} represents a perfluorinated polyether group, X represents a bond or a linking group, R¹ represents a hydrogen atom or an alkyl group of 1 to 4 carbon atoms, and n is 1 or 2; and
(b) at least one non-fluorinated monomer having at least one hydrophilic group or a precursor thereof; and
(ii) conversion of said precursor when present, into a corresponding hydrophilic group.

2. Fluorinated surfactant according to claim 1 wherein said hydrophilic group is selected from the group consisting of non-ionic groups, cationic groups, anionic groups and combinations thereof.

3. Fluorinated surfactant according to claim 1 wherein said fluorinated surfactant is a nonionic surfactant, cationic surfactant, anionic surfactant or amphoteric surfactant.

4. Fluorinated surfactant according to claim 1 wherein said hydrophilic group is a non-ionic group comprising polyoxyalkylene units of which the alkylene moiety has 2, 3, or 4 carbon atoms.

5. Fluorinated surfactant according to claim 1 wherein said hydrophilic group is a carboxylic or sulphonic acid or salt thereof.

6. Fluorinated surfactant according to claim 1 wherein said hydrophilic group is an ammonium group or an amino-oxide group.

7. Fluorinated surfactant according to claim 1 wherein said fluorinated surfactant has a weight average molecular weight of at least 1000 g/mol.

8. Fluorinated surfactant according to claim 1 wherein said fluorinated surfactant has a weight average molecular weight of not more than 100,000 g/mol.

9. Fluorinated surfactant according to claim 1 wherein the weight ratio of fluorinated units to hydrophilic non-fluorinated units is between 80:20 and 1:99.

10. Fluorinated surfactant according to claim 1 wherein said perfluorinated polyether corresponds to the general formula:
CF₃CF₂CF₂O[CF(CF₃)CF₂O]ₖCF(CF₃)—
wherein k has a value of at least 1.

11. Fluorinated surfactant according to claim 10 wherein the amount of fluorinated surfactants having a perfluorinated polyether group with a weight average molecular weight of 750 g/mol or less is not more than 10% by weight based on the total weight of the fluorinated surfactant.

12. Fluorinated surfactant according to claim 1 wherein said fluorinated surfactant has a solubility of at least 0.001% by weight at 20° C. in at least one solvent selected from the group consisting of water and a non-fluorinated organic solvent.

13. Composition comprising an organic or aqueous liquid having dispersed or dissolved therein a fluorinated surfactant according claim 1.

14. Composition according to claim 13 wherein the amount of said fluorinated surfactant is between 0.001 and 1% by weight.

15. Method of altering the surface energy and/or interfacial free energy of a liquid medium, said method comprising 1) providing a liquid medium and 2) incorporating a fluorinated surfactant as defined in claim 1 therein.
